(19) United States
(12) Patent Application Publication
(10) Pub. No.: US 2010/0068609 A1
(43) Pub. Date: Mar. 18, 2010

(54) HYBRID CELL CONSTRUCTION FOR IMPROVED PERFORMANCE

(75) Inventor: Xinrong Wang, Fairport, NY (US)

Correspondence Address: BASCH & NICKERSON LLP, 1777 PENFIELD ROAD, PENFIELD, NY, 14526, US

(73) Assignee: Ultralife Corportion, Newark, NY (US)

(21) Appl. No.: 12/557,234

(22) Filed: Sep. 10, 2009

Related U.S. Application Data
(60) Provisional application No. 61/096,954, filed on Sep. 15, 2008.

(51) Int. Cl. H01M 6/10

(52) U.S. Cl. 429/94; 29/623.2

(57) ABSTRACT

A hybrid lithium electrochemical cell comprising a spirally wound cathode, separator and anode in a generally cylindrical structure with the packaging materials and terminal structure of a pouch cell. The cell may also contain a welded metal grid outside the pouch cell packaging material to insure a cylindrical shape. The resultant hybrid cell features improved capacity and specific energy.

This application claims priority from U.S. Provisional Application No. 61/096,954 for “HYBRID CELL CONSTRUCTION FOR IMPROVED PERFORMANCE,” filed Sep. 15, 2008 by Xinrong Wang, which is also hereby incorporated by reference in its entirety.

The following disclosure relates to the construction of lithium cells, and particularly to a hybrid configuration featuring a pouch-type cell package having a spiral structure. The hybrid cell is composed of cathode, separator and anode spirally wound in a generally cylindrical form, filled with electrolyte and packaged with the materials and terminal structure of a pouch cell. The hybrid cell may also contain a metal grid or mesh outside the pouch cell packaging material to control the cylindrical shape. The disclosed hybrid cell shows improvements in capacity, specific energy and energy density over prior pouch cells due to its construction.

### BACKGROUND AND SUMMARY

The dissemination of and advances in various portable electronic equipment, such as note-book computers and video cameras, has been accompanied by heightened demand for higher performance batteries as drive sources for these devices, with attention being focused particularly on lithium batteries and lithium ion secondary batteries. As lithium batteries and lithium ion secondary batteries have high voltages, their energy density is also high, contributing significantly to the downsizing and reduction in weight of portable electronic equipment.

Further movement towards smaller, lighter and more sophisticated portable electronic equipment, however, has given rise to even stronger demands for high performance batteries, and in turn a need to boost energy density, even in lithium batteries and lithium ion secondary batteries, as well as reliability and safety.

The most widely used packaging for lithium batteries is the cylindrical cell. A cylindrical battery comprises a plate group obtained by spirally winding a thin positive electrode plate and a thin negative electrode plate with a separator interposed therebetween received in a closed-end cylindrical battery container. The cylindrical cell is easy to manufacture, offers high rate capability and provides good mechanical stability. The drawbacks of the cylindrical cell include its specific energy and poor space utilization. Because of fixed cell size, a battery pack must be designed around such cell sizes.

The introduction of the pouch cell in 1995 made a profound advancement in cell design. Rather than using expensive metallic enclosures and glass-to-metal electrical feed-throughs, a heat-sealable foil is used. The electrical contacts consist of conductive foil tabs that are welded to the electrode and sealed to the pouch material. The pouch cell concept allows tailoring to exact cell dimensions. It makes the most efficient use of available space and achieves a packaging efficiency of 90 to 95 percent—the highest among battery packs. Because of the absence of a metal can, the pouch pack is lightweight. These properties are particularly useful for military applications where portable, lightweight and flexible power sources are desired. Other applications include wearable power sources, as well as metering, telematic, security, and medical applications. The current disadvantages of the pouch cell include lower rate capability and load current as well as damage susceptibility due its soft packaging.

One aspect of the disclosure relates to the construction of a hybrid cell for primary (i.e., non-rechargeable) battery and a secondary (i.e., rechargeable) battery combining the configurations of the pouch cell package and the spiral structure of the cylindrical cell. The hybrid cell is composed of spirally wound cathode, separator and anode in a cylindrical structure with the packaging materials and terminal structure of a pouch cell. The cell may also contain a metal grid (e.g., grid sheet welded end-to-end) outside the pouch cell packaging material to insure a cylindrical shape. The resultant hybrid cell features improved capacity, specific energy and energy density.

### BRIEF DESCRIPTION OF THE DRAWINGS

A more complete appreciation of the disclosed embodiments and the attendant advantages thereof will be readily obtained as the same are illustrated and described by reference to the following detailed description when considered in connection with the accompanying drawings, wherein:

FIG. 1 depicts a final hybrid cell configuration in accordance with the disclosed embodiments;

FIG. 2 depicts the hybrid cell of FIG. 1, with a surrounding metal grid;

FIG. 3 is a cutaway view of the cell of FIG. 1, depicting the structure of the hybrid cell;

FIG. 4 is a graph depicting the discharge profile of the hybrid cell under constant current of 2 amperes at 23 deg C.;

FIG. 5 is a graph depicting the discharge profile of the hybrid cell under constant current of 1 ampere at 23 deg C.;

FIG. 6 is a graph depicting the discharge profile of the hybrid cell under constant current of 500 milliamperes at 23 deg C.; and

FIG. 7 is a graph depicting the discharge profile of the hybrid cell under constant current of 250 milliamperes at 23 deg C.

### DETAILED DESCRIPTION

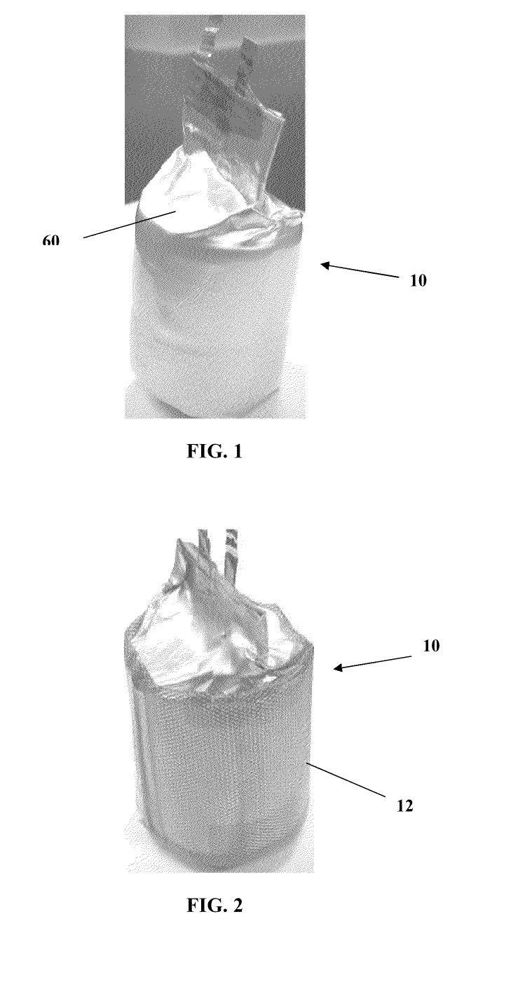

This disclosure relates to the construction of a hybrid lithium primary or secondary cell that combines the configurations of a pouch cell package with the spiral electrode structure of a cylindrical cell. Specifically the hybrid cell 10, as depicted in FIG. 1, includes spirally wound cathode, separator and anode with the packaging material and terminal structure of a pouch-type cell. Referring also to FIG. 2, the hybrid cell may contain a welded metal grid or mesh 12 outside the pouch cell packaging material to encourage the cell to retain the generally cylindrical shape illustrated. It will be appreciated that the grid may facilitate other cross-sectional shapes dependent upon the constraints of the compartment in which the battery is to operate.

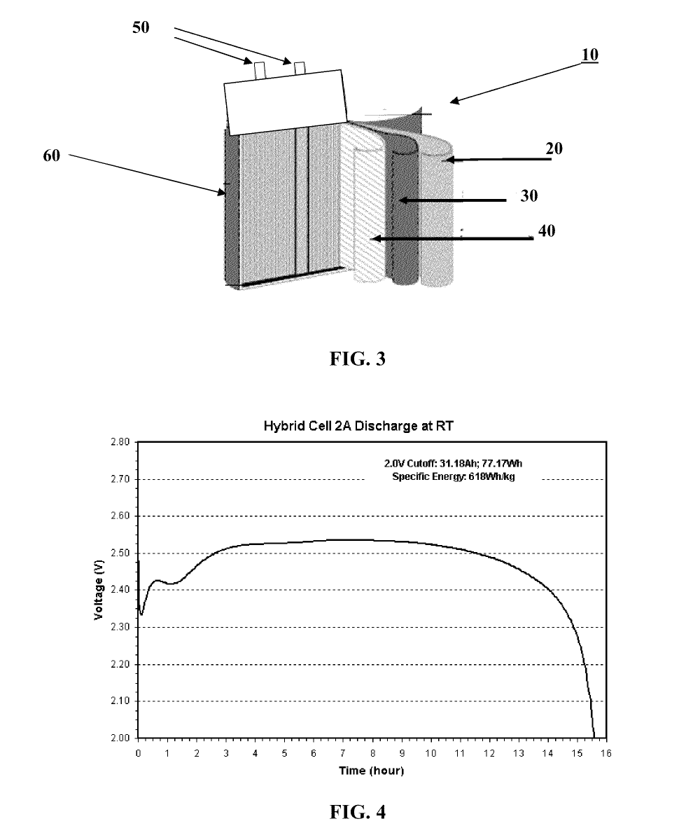

A more detailed description of the hybrid cell 10 is provided with respect to FIG. 3. The spirally wound electrode assembly is manufactured by preparing sheets of the anode 20 and cathode 40 materials and cutting these sheets into the form of a band having a predetermined width and length. The anode 20 and cathode 40 materials are separated from each other using a separator 30 which is designed for maximum physical integrity and has thermal shutdown capability. As illustrated in FIG. 3, the anode and cathode, with the separator between them, are wound together in a spiral shape. Metal tabs 50 are welded to the respective anode 20 and cathode 40 materials to act as current collectors and are sealed to the aluminum laminated plastic pouch 60. Finally the pouch is filled with electrolyte to activate the battery.

In one of the disclosed embodiments, the anode 20 includes lithium or a lithium alloy. The lithium alloy includes one more metals including, but not limited to, magnesium, aluminum and silicon. The anode 20 of the electrochemical cell may also be made of other materials such as sodium and magnesium. The materials used for cathode 40 may include manganese dioxide, iron sulfide, carbon fluoride, cobalt oxide, iron phosphate and combinations of these (such as CFₓ—MnO₂ cathode). For lithium rechargeable batteries, possible configurations include Li-ion rechargeable cells such as lithium cobalt oxide, lithium iron phosphate and lithium manganese oxide, and Lithium-polymer rechargeable cells. For the hybrid cells with configurations of a pouch cell package and structure of cylindrical cell, a metal tab 50 is welded to anode 20 of the jellyroll, and another tab 50 is welded to cathode 40 of the jellyroll. Both tabs of the negative electrode and the positive electrode are thermally sealed to the Aluminum laminated plastic pouch 60. Also contemplated is an electrochemical cell where the anode material is a lithium secondary anode selected such as graphite and carbon/silicon composites. It will be further appreciated that the cell structure disclosed herein may be used for a number of battery chemical configurations, including those disclosed in U.S. application Ser. No. 12/145,665 for “HIGH CAPACITY AND HIGH RATE LITHIUM CELLS WITH CFx-Mno2 HYBRID CATHODE,” filed Jun. 25, 2008 by X. Zhang and X. Wang, which is hereby incorporated by reference in its entirety.

The electrolyte may comprise a nonaqueous solution including a lithium salt and a solvent. Some lithium salts that may be suitable include LiAsF₆, LiPF₆, LiBF₄, LiCIO₄, LiI, LiBr, LiAlCl₄, Li(CF₃SO₃), LiN(CF₃SO₂)₂, LiB(C₂O₄)₂ and LiB(C₆H₄O₂)₂. The concentration of the salt in the electrolyte may have a range from about 0.1 to about 1.5 moles per liter. The solvents may comprise one or a mixture of organic chemicals that include carbonate, nitrile and phosphate and include ethylene carbonate, propylene carbonate, 1,2-Dimethoxyethane, tetrahydrofuran, 1,3-dioxolane, ethyl methyl carbonate, butylene carbonate, dimethyl carbonate, diethyl carbonate, gamma-butyrolactone, acetonitrile, triethylphosphate and tri methyl phosphate.

The separator can be formed from any of a number of materials, the typical separator materials used in lithium primary and secondary cells, and preferably provide a thermal shutdown functional separator. The separator includes, in one embodiment, a laminated structure of polypropylene and polyethylene. The thermal shutdown capability of the separator is the result of polyethylene melting down in the sandwich structure laminated polypropylene and polyethylene, when the system temperature rises higher than its melting point.

### EXAMPLES

The practice of one or more aspects of the disclosed embodiments are illustrated in more detail in the following non-limiting examples.

A hybrid cell was constructed using a lithium anode, an electrolyte comprising LiClO₄ salt with solvents of propylene carbonate, tetrahydrofuran and 1,2-dimethoxyethane, a separator including laminated polypropylene and polyethylene, and a hybrid homogeneous cathode with approximately 80% of CFₓ wherein x was about 1.1, and 20% of electrolytic manganese dioxide by weight. The hybrid cell was built using spirally wound electrodes with the separator between and packaged as a pouch cell as described above.

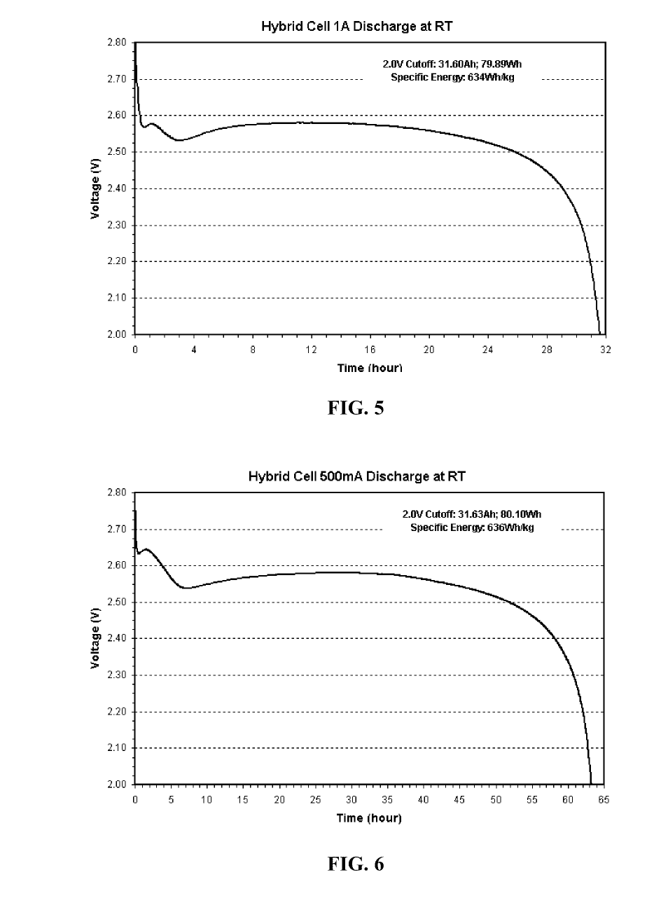

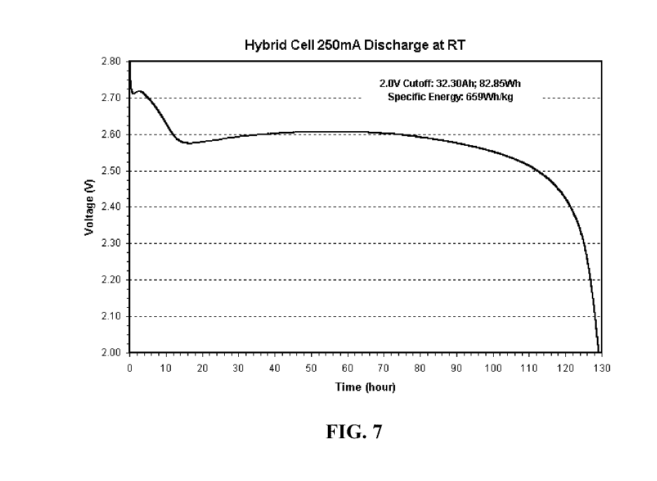

The hybrid cell was tested over various discharge currents at ambient temperature. The discharge currents of the cell under constant currents of 2 amperes (A), 1 ampere (A), 500 milliamperes (mA) and 250 milliamperes (mA) at ambient temperature are shown in FIGS. 4, 5, 6 and 7, respectively. A summary of the capacity (Ah), energy (Wh) and specific energy (Wh/kg) for the hybrid cell under these currents is summarized in TABLE A below:

TABLE A
Summary of Hybrid Cell Performance

| | Capacity | Energy | Specific Energy |
|---|---|---|---|
| Discharge Conditions | (Ah) | (Wh) | (Wh/kg) |
| 2 A constant current | 31.18 | 77.17 | 618 |
| 1 A constant current | 31.60 | 79.89 | 634 |
| 500 mA constant current | 31.63 | 80.10 | 636 |
| 250 mA constant current | 32.30 | 82.85 | 659 |

For example, the improved cells of Table A reflect capacities of at least about 30 Ah. Similarly, the energy of the cells represented in Table A, at least about 75 Wh, and the specific energy, at least about 600 Wh/kg. As will be appreciated alternative capacities and energies, which may be greater or less than those indicated in Table A may be achieved as a result of modification of the embodiment described (e.g., alternative materials, sizes, etc.). In general, the specific energy of the described embodiments will be greater than those of similarly-sized “conventional” battery configurations due to the can material change of the cylindrical cell structure. It should be further appreciated that the disclosed embodiments therefore provide improved performance over similar-sized or similar-weight conventional batteries.

For comparison, various lithium batteries featuring different cathode materials in a cylindrical configuration, i.e. D-cell were evaluated under constant current at ambient temperature. A summary of the capacity (Ah), energy (Wh) and specific energy (Wh/kg) for these D-cells is summarized in TABLE B below:

TABLE B
Summary of Performance for D-cells with different chemistries

| | Capacity | Energy | Specific Energy |
|---|---|---|---|
| D-cell Chemistry | (Ah) | (Wh) | (Wh/kg) |
| Li/MnO₂ | 11 | 32.20 | 280 |
| Li/SO₂ | 7.5 | 21.25 | 250 |
| Li/CFₓ | 16.8 | 43.02 | 566 |
| Li/SOCl₂ | 13 | 29.00 | 290 |

A comparison of Tables A and B shows a considerable improvement in energy, capacity and specific energy for the lithium cells in the hybrid configuration disclosed herein. Based on the selection of anodes and cathodes having high energy density and rate capability, the hybrid cells result in lighter weights through the use of pouch cell aluminum laminate packaging materials, which are much lighter than a metal can, so that the cells have high specific energy. The hybrid cells exhibit high capacity and high rate capability due to the jellyroll anode, separator and cathode structure in a cylindrical configuration.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A hybrid electrochemical cell comprising:
a spiral electrode structure;
an electrolyte; and
a pouch-type package for said spiral electrode structure and electrolyte.

2. The electrochemical cell of claim 1, wherein said spiral electrode structure comprises:
a cathode;
an anode; and
a separator, wherein said cathode, anode and separator are spirally wound with respect to one another.

3. The electrochemical cell of claim 2, wherein:
the cathode is a flexible band;
the anode is a flexible band; and
the separator is a flexible band, wherein said cathode and anode with the separator therebetween are spirally wound together.

4. The electrochemical cell of claim 2 wherein the spirally wound cathode, anode and separator are in a generally cylindrical shape.

5. The electrochemical cell according to claim 1, wherein said electrochemical cell exhibits a specific energy of at least about 600 Wh/kg.

6. The electrochemical cell according to claim 1, further comprising a metal grid outside the pouch-type package to maintain a desired shape.

7. The electrochemical cell according to claim 1 wherein said cell is a primary cell.

8. The electrochemical cell according to claim 1 wherein said cell is a secondary cell.

9. The electrochemical cell according to claim 1, where cathode materials for the cell are selected from the group consisting of:
manganese dioxide; and
iron sulfide; and
carbon fluoride; and
cobalt oxide; and
iron phosphate; and
combinations thereof.

10. The electrochemical cell according to claim 1, wherein the anode material is selected from the group consisting of:
lithium; and
lithium alloy; and
sodium; and
magnesium; and
graphite; and
carbon/silicon composites.

11. The electrochemical cell according to claim 1, wherein the electrolyte comprises a nonaqueous solution including a lithium salt and a solvent.

12. The electrochemical cell according to claim 11, wherein the nonaqueous electrolyte solution comprises lithium salts selected from the group consisting of: LiAsF₆, LiPF₆, LiBF₄, LiClO₄, LiI, LiBr, LiAlCl₄, Li(CF₃SO₃), LiN(CF₃SO₂)₂, LiB(C₂O₄)₂ and LiB(C₆H₄O₂)₂.

13. The electrochemical cell according to claim 12, wherein the concentration of the lithium salt in the electrolyte is within a range from about 0.1 to about 1.5 moles per liter.

14. The electrochemical cell according to claim 11, wherein the nonaqueous electrolyte solution comprises solvent in a mixture of organic chemicals at least one of which is selected from the group consisting of: carbonate, nitrile, phosphate, ethylene carbonate, propylene carbonate, 1,2-Dimethoxyethane, tetrahydrofuran, 1,3-dioxolane, ethyl methyl carbonate, butylene carbonate, dimethyl carbonate, diethyl carbonate, gamma-butyrolactone, acetonitrile, triethylphosphate and tri methyl phosphate.

15. The electrochemical cell according to claim 2, wherein the separator includes a laminated structure of polypropylene and polyethylene.

16. The electrochemical cell according to claim 1, wherein the pouch-type package includes an aluminum laminated plastic pouch.

17. The electrochemical cell according to claim 1, wherein the capacity and specific energy of the said cell are the function of the size of the cell.

18. A method of assembling a hybrid lithium primary electrochemical cell comprising:
winding a cathode, a separator, and an anode together;
placing the spirally winding cathode, separator, and anode into a pouch, with electrodes connected to the anode and cathode extending out of the pouch;
filling the pouch with an electrolyte; and
sealing the pouch, with the electrodes extending from the pouch.

19. The method according to 18, further comprising placing the pouch inside a metal grid to maintain a desired shape.

20. The method according to claim 18, wherein winding the cathode, the separator, and the anode together includes rolling them as in a jellyroll configuration.
